(19) United States
(12) Patent Application Publication
(10) Pub. No.: US 2025/0016533 A1
(43) Pub. Date: Jan. 9, 2025

(54) CONFIGURING BUFFERING BASED ON INFORMATION IN A CONTAINER

(71) Applicant: Lenovo (Singapore) Pte. Ltd., New Tech Park (SG)

(72) Inventors: Roozbeh Atarius, La Jolla, CA (US); Dimitrios Karampatsis, Ruislip (GB)

(21) Appl. No.: 18/704,866

(22) PCT Filed: Oct. 25, 2022
(86) PCT No.: PCT/IB2022/060248

§ 371 Date: Apr. 25, 2024

Related U.S. Application Data
(60) Provisional application No. 63/271,671, filed on Oct. 25, 2021.

(51) Int. Cl. H04W 4/44; H04W 12/08

(52) U.S. Cl. CPC H04W 4/44; H04W 12/08

(57) ABSTRACT

Apparatuses, methods, and systems are disclosed for configuring buffering based on information in a container. One method (1400) includes receiving (1402), at a device, from a network entity, a message including a container, the container including: a subset of information of a set of information; a segment number that identifies the subset of information; and an indicator that indicates existence of a future subset of information of the set of information. The method (1400) includes buffering (1404) data based at least in part on the subset information of the set of information and the segment number. The method (1400) includes analyzing (1406) the buffered data in response to the indicator indicating no existence of the future subset of information of the set of information.

### CROSS-REFERENCE TO RELATED APPLICATIONS

This application claims priority to U.S. Patent Application Ser. No. 63/271,671 entitled “APPARATUSES, METHODS, AND SYSTEMS FOR TRANSMISSION OF PROTOCOL CONFIGURATION OPTIONS” and filed on Oct. 25, 2021 for Roozbeh Atarius et al., which is incorporated herein by reference in its entirety.

### FIELD

The subject matter disclosed herein relates generally to wireless communications and more particularly relates to configuring buffering based on information in a container.

### BACKGROUND

In certain wireless communications systems, wireless communications may be performed by vehicles that are unmanned. There may be limitations on information transmitted to and/or from such vehicles.

### BRIEF SUMMARY

Methods for configuring buffering based on information in a container are disclosed. Apparatuses and systems also perform the functions of the methods. One embodiment of a method includes receiving, at a device, from a network entity, a message including a container, the container including: a subset of information of a set of information; a segment number that identifies the subset of information; and an indicator that indicates existence of a future subset of information of the set of information. In some embodiments, the method includes buffering data based at least in part on the subset information of the set of information and the segment number. In certain embodiments, the method includes analyzing the buffered data in response to the indicator indicating no existence of the future subset of information of the set of information.

One apparatus for configuring buffering based on information in a container includes a processor. In some embodiments, the apparatus includes a memory coupled to the processor, the processor configured to cause the apparatus to: receive, from a network entity, a message including a container, the container including: a subset of information of a set of information; a segment number that identifies the subset of information; and an indicator that indicates existence of a future subset of information of the set of information; buffer data based at least in part on the subset of information of the set of information and the segment number; and analyze the buffered data in response to the indicator indicating no existence of the future subset of information of the set of information.

Another embodiment of a method for configuring buffering based on information in a container includes receiving, at a first network entity, from a device, a first message comprising a first container, the first container including: a first subset of information of a first set of information; a first segment number that identifies the first subset of information; and a first indicator that indicates existence of a first future subset of information of the first set of information. In some embodiments, the method includes buffering data based at least in part on the first subset of information of the first set of information and the first segment number. In certain embodiments, the method includes performing a procedure on the buffered data in response to the first indicator indicating no existence of the first future subset of information of the first set of information.

Another apparatus for configuring buffering based on information in a container includes a processor. In some embodiments, the apparatus includes a memory coupled to the processor, the processor configured to cause the apparatus to: receive, from a device, a first message including a first container, the first container including: a first subset of information of a first set of information; a first segment number that identifies the first subset of information; and a first indicator that indicates existence of a first future subset of information of the first set of information; buffer data based at least in part on the first subset of information of the first set of information and the first segment number; and perform a procedure on the buffered data in response to the first indicator indicating no existence of the first future subset of information of the first set of information.

A further embodiment of a method for configuring buffering based on information in a container includes receiving, at a device, from a network entity, a message including a container, the container including: a subset of information of a set of information; and an indicator that indicates existence of a future subset of information of the set of information. In some embodiments, the method includes buffering data based at least in part on the subset of information of the set of information. In certain embodiments, the method includes analyzing the buffered data in response to the indicator indicating no existence of the future subset of information of the set of information.

A further apparatus for configuring buffering based on information in a container includes a processor. In some embodiments, the apparatus includes a memory coupled to the processor, the processor configured to cause the apparatus to: receive, from a network entity, a message including a container, the container including: a subset of information of a set of information; and an indicator that indicates existence of a future subset of information of the set of information; buffer data based at least in part on the subset of information of the set of information; and analyze the buffered data in response to the indicator indicating no existence of the future subset of information of the set of information.

Another embodiment of a method for configuring buffering based on information in a container includes receiving, at a first network entity, from a device, a first message including a first container, the first container including: a first subset of information of a first set of information; and a first indicator that indicates existence of a first future subset of information of the first set of information. In some embodiments, the method includes buffering data based at least in part on the first subset of information of the first set of information. In certain embodiments, the method includes performing a procedure on the buffered data in response to the first indicator indicating no existence of the first future subset of information of the first set of information.

Another apparatus for configuring buffering based on information in a container includes a processor. In some embodiments, the apparatus includes a memory coupled to the processor, the processor configured to cause the apparatus to: receive, from a device, a first message including a first container, the first container including: a first subset of information of a first set of information; and a first indicator that indicates existence of a first future subset of information of the first set of information; buffer data based at least in part on the first subset of information of the first set of information; and perform a procedure on the buffered data in response to the first indicator indicating no existence of the first future subset of information of the first set of information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring buffering based on information in a container;

FIG. 2 is a schematic block diagram illustrating one embodiment of an apparatus that may be used for configuring buffering based on information in a container;

FIG. 3 is a schematic block diagram illustrating one embodiment of an apparatus that may be used for configuring buffering based on information in a container;

FIG. 4 is a schematic block diagram illustrating one embodiment of a system in which there is an uncrewed aerial system (“UAS”) service supplier (“USS”) uncrewed aerial vehicle (“UAV”) authorization and/or authentication (“UUAA”) during public data network (“PDN”) connection establishment at an attach procedure in evolved packet system (“EPS”);

FIG. 5 is a schematic block diagram illustrating one embodiment of a protocol configuration option (“PCO”) information element (“IE”) and an extended protocol configuration option (“ePCO”) IE;

FIG. 6 is a schematic block diagram illustrating one embodiment of a system for UUAA and command and control (“C2”) authorization at PDN connection establishment when attaching to EPS;

FIG. 7 is a schematic block diagram illustrating one embodiment of a system for a user equipment (“UE”) initiated completion of data for UUAA and possible C2 authorization;

FIG. 8 is a schematic block diagram illustrating one embodiment of a system for a container for ePCO;

FIG. 9 is a schematic block diagram illustrating one embodiment of a system for a container for PCO;

FIG. 10 is a schematic block diagram illustrating one embodiment of a system for network initiated completion of data for re-UUAA;

FIG. 11 is a schematic block diagram illustrating one embodiment of a system for UUAA and C2 authorization at PDN connection establishment when attaching to EPS;

FIG. 12 is a schematic block diagram illustrating one embodiment of a system with a container for ePCO;

FIG. 13 is a schematic block diagram illustrating one embodiment of a system with a container for PCO;

FIG. 14 is a flow chart diagram illustrating one embodiment of a method for configuring buffering based on information in a container;

FIG. 15 is a flow chart diagram illustrating another embodiment of a method for configuring buffering based on information in a container;

FIG. 16 is a flow chart diagram illustrating a further embodiment of a method for configuring buffering based on information in a container; and

FIG. 17 is a flow chart diagram illustrating yet another embodiment of a method for configuring buffering based on information in a container.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

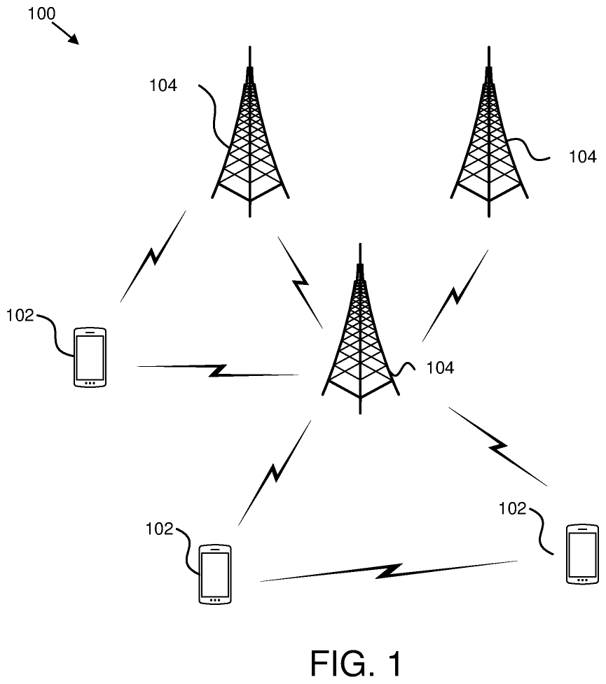

FIG. 1 depicts an embodiment of a wireless communication system 100 for configuring buffering based on information in a container. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, from a network entity, a message including a container, the container including: a subset of information of a set of information; a segment number that identifies the subset of information; and an indicator that indicates existence of a future subset of information of the set of information. In some embodiments, the network unit 104 may buffer data based at least in part on the subset information of the set of information and the segment number. In certain embodiments, network unit 104 may analyze the buffered data in response to the indicator indicating no existence of the future subset of information of the set of information. Accordingly, the network unit 104 may be used for configuring buffering based on information in a container.

In certain embodiments, a network unit 104 may receive, from a device, a first message comprising a first container, the first container including: a first subset of information of a first set of information; a first segment number that identifies the first subset of information; and a first indicator that indicates existence of a first future subset of information of the first set of information. In some embodiments, the network unit 104 may buffer data based at least in part on the first subset of information of the first set of information and the first segment number. In certain embodiments, the network unit 104 may perform a procedure on the buffered data in response to the first indicator indicating no existence of the first future subset of information of the first set of information. Accordingly, the network unit 104 may be used for configuring buffering based on information in a container.

In certain embodiments, a network unit 104 may receive, from a network entity, a message including a container, the container including: a subset of information of a set of information; and an indicator that indicates existence of a future subset of information of the set of information. In some embodiments, the network unit 104 may buffer data based at least in part on the subset of information of the set of information. In certain embodiments, the network unit 104 may analyze the buffered data in response to the indicator indicating no existence of the future subset of information of the set of information. Accordingly, the network unit 104 may be used for configuring buffering based on information in a container.

In certain embodiments, a network unit 104 may receive, from a device, a first message including a first container, the first container including: a first subset of information of a first set of information; and a first indicator that indicates existence of a first future subset of information of the first set of information. In some embodiments, the network unit 104 may buffer data based at least in part on the first subset of information of the first set of information. In certain embodiments, the network unit 104 may perform a procedure on the buffered data in response to the first indicator indicating no existence of the first future subset of information of the first set of information. Accordingly, the network unit 104 may be used for configuring buffering based on information in a container.

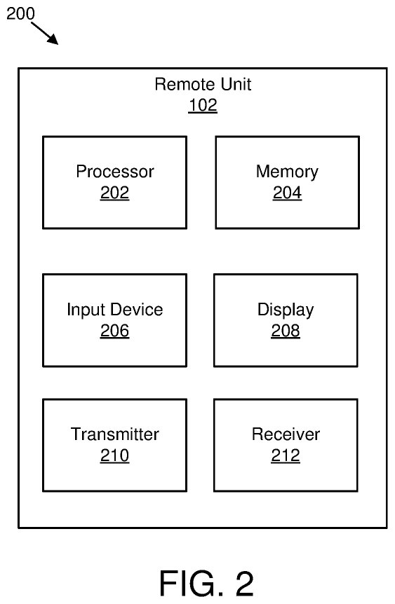

FIG. 2 depicts one embodiment of an apparatus 200 that may be used for configuring buffering based on information in a container. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

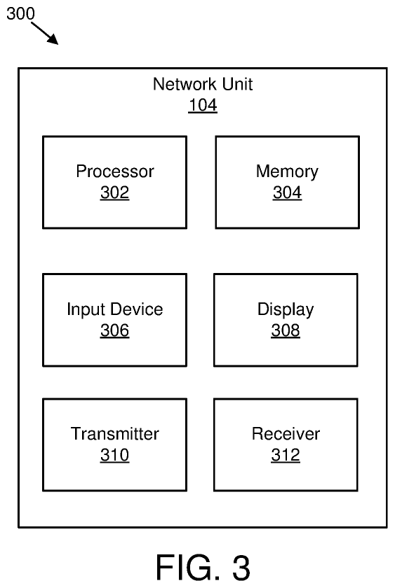

FIG. 3 depicts one embodiment of an apparatus 300 that may be used for configuring buffering based on information in a container. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the apparatus 300 to: receive, from a network entity, a message including a container, the container including: a subset of information of a set of information; a segment number that identifies the subset of information; and an indicator that indicates existence of a future subset of information of the set of information; buffer data based at least in part on the subset of information of the set of information and the segment number; and analyze the buffered data in response to the indicator indicating no existence of the future subset of information of the set of information.

In some embodiments, the processor 302 is configured to cause the apparatus 300 to: receive, from a device, a first message including a first container, the first container including: a first subset of information of a first set of information; a first segment number that identifies the first subset of information; and a first indicator that indicates existence of a first future subset of information of the first set of information; buffer data based at least in part on the first subset of information of the first set of information and the first segment number; and perform a procedure on the buffered data in response to the first indicator indicating no existence of the first future subset of information of the first set of information.

In certain embodiments, the processor 302 is configured to cause the apparatus 300 to: receive, from a network entity, a message including a container, the container including: a subset of information of a set of information; and an indicator that indicates existence of a future subset of information of the set of information; buffer data based at least in part on the subset of information of the set of information; and analyze the buffered data in response to the indicator indicating no existence of the future subset of information of the set of information.

In some embodiments, the processor 302 is configured to cause the apparatus 300 to: receive, from a device, a first message including a first container, the first container including: a first subset of information of a first set of information; and a first indicator that indicates existence of a first future subset of information of the first set of information; buffer data based at least in part on the first subset of information of the first set of information; and perform a procedure on the buffered data in response to the first indicator indicating no existence of the first future subset of information of the first set of information.

It should be noted that one or more embodiments described herein may be combined into a single embodiment.

In certain embodiments, UAS requires that a PDN connectivity and UUAA during that PDN connection is mandated for both a UE and a network. In an EPS, during an attach procedure and a corresponding PDN connection establishment, the network may support UUAA during a PDN connection establishment. The UAV may support UUAA during the PDN connection establishment procedure.

In some embodiments, during PDN connectivity and UUAA, a UE is required to transmit the following information: 1) a civil aviation administration (“CAA”)-Level UAV identifier (“ID”) of the UAV; 2) a USS address; and 3) a UUAA aviation payload.

If the UE is also considering the PDN connection for C2 communications, the UE is to transmit the following information: 1) a UAS container including UAV UAV-controller (“C”) pairing information; and 2) flight authorization information.

In various embodiments, a UE transmits the information for the UUAA and the C2 communications, then after the PDN connection is established and the UE gets UUAA authorized, the USS server initiates a procedure for C2 authorization.

In certain embodiments, an architecture supports UAS services and supports an inter-system change with a fifth generation system (“5GS”). The architecture requirements are that there is no impact on EPS except a PDN gateway (“GW”) (“PGW”). Therefore, a mobile management entity (“MME”) and serving gateway (“SGW”) may not have any impact. Since the PGW has also SMF functionality, it supports extended protocol options information element with the maximum length of 65,535 octets, however, the support for ePCO is not clear by the MME and the serving GW. The use of a protocol configuration options is to implement the USS services for EPS with no impact on MME and SGW.

In some embodiments, due to a limitation of a container payload of a PCO, the following problems may exist: 1) a container payload of PCO or ePCO may not be adequate for data transportation; 2) a UE at time of attach may not know that MME supports ePCO; and 3) if the MME or SGW do not support ePCO, data for USS services may need to be transferred between the UE and the PDN GW.

In various embodiments, an architecture for UAVs may have the following functionality: 1) authentication and authorization of a UAV with the USS during 5GS registration; 2) authentication and authorization of a UAV with the USS during protocol data unit (“PDU”) session establishment and PDN connection establishment; 3) support for USS authorization of C2 communication; 4) a reference model for UAV tracking may support three UAV tracking modes: 1) UAV location reporting mode; 2) UAV presence monitoring mode; and 3) unknown UAV tracking mode.

In certain embodiments, a 3GPP system supports geofencing (e.g., for in-flight UAV) and geocaging (e.g., for UAV on the ground intending to fly) functionality in USS by providing enablers such as location services, event notification to a subscribing USS, and so forth.

It should be noted that geofencing and/or geocaging mechanisms are an air traffic control functionality performed by the USS. The 3GPP system provides enablers to support geofencing and/or geocaging functionality in USS (e.g., location services, enablement of C2 connectivity, event notification to a subscribing USS, and so forth).

In some embodiments, 3GPP covers UAV functionality provided by a fifth generation core (“5GC”) connected to next generation (“NG”)-radio access network (“RAN”) and evolved packet core (“EPC”) connected to LTE. Functionalities in 3GPP is defined for UAV support in the 3GPP system and depending on 3GPP network operator and/or regulatory requirements, the UUAA is performed: 1) in 5GS either as a separate procedure during the 5GS registration procedure (e.g., optional and based on specific PLMN policies, USS requirements, and geographic regulatory requirements), or when the UAV requests user plane resources for UAV operation (e.g., PDU session establishment)—the UAV may support UUAA during registration and PDU session establishment procedure—the network may support UUAA during PDU session establishment; 2) in EPS during the attach procedure and the corresponding PDN connection establishment—the network may support UUAA during PDN connection establishment—the UAV may support UUAA during PDN connection establishment procedure.

More functionalities in 3GPP are defined as: 1) a UAV that is provisioned with a CAA-Level UAV ID may provide the CAA-Level UAV ID in 5GS in both registration and in PDU session establishment—in EPC, a UAV that is provisioned with a CAA-Level UAV ID provides the CAA-Level UAV ID in PDN connection establishment in session management (“SM”)—PCO—the core network (“CN”) may determine whether UUAA is executed at 5GS registration or at PDU session and/or PDN connection establishment based on local policies; 2) if UUAA is not performed during the registration procedure in 5GS, the UUAA is performed at PDU session establishment when the UAV requests user plane resources for UAV operation and the UAV provides its CAA Level ID during PDU session (e.g., PDN connection) establishment; 3) the UAV flight authorization and UAV-UAV-C pairing authorization is performed at PDU session and/or PDN connection establishment and/or modification procedures; 4) the 3GPP system supports USS authorization of pairing between a UAV and a networked UAV-C or a UAV-C that connects to the UAV via Internet connectivity during either the establishment of the PDN connection and/or PDU session for C2 communication or a modification of a PDN connection and/or PDU session either dedicated to C2 communication or common to USS communication and C2 communication—modifications of the pairing or re-authorization take place via modification of the established PDN connection and/or PDU session—during such procedures, the USS provides to the 3GPP system information (e.g., quality of service (“QoS”) requirement, data flow descriptors, and so forth) that enable traffic between the UAV and the UAV-C; and 5) for EPC, the PDN connections used by UAV are served by SMF+PGW-C regardless of whether the UAV support 5G non-access stratum (“NAS”) or whether their subscription allows access to 5GC—the access point names (“APNs”) used by the UAV for contacting USS or for C2 communication always resolves to a SMF+PGW-C.

In various embodiments, the 3GPP has the following architectural assumptions: 1) it is assumed that the UAV trying to access UAS services using 3GPP connectivity is already registered with a USS and has been assigned a CAA-Level-UAV ID—the USS assigns to the UAV a CAA-Level UAV ID, or is made aware of the assigned CAA-Level UAV ID; 2) a UAV is registered with the USS either before connecting with the 3GPP system or using plain internet connectivity via the 3GPP system—before registering for UAS services with the 3GPP system, the UAV may be provisioned with a CAA-Level UAV identity; 3) in roaming scenarios, it is assumed that access to USS is in the visiting public land mobile network (“PLMN”) (“VPLMN”), thus packet data connectivity for UAV-USS communication is in local breakout, and the UAS network function (“NF”) is located in the VPLMN; and 4) the UAV uses 3GPP access (e.g., LTE & NR) for 3GPP UAV related operations.

In certain embodiments, the SMF+PGW-C implements the functions defined in 3GPP, and the SMF+PGW-C: 1) triggers the UUAA-SM procedure for a UE requiring UAV authentication and authorization by a USS when requesting user plane resources for UAV operation, or when the USS and/or uncrewed aerial system traffic management (“UTM”) that authenticated the UAV triggers a re-authentication; and 2) may trigger the authorization of pairing between a UAV and a networked UAV-C or a UAV-C that connects to the UAV via internet connectivity during the establishment of the PDN connection and/or PDU session for C2 communication.

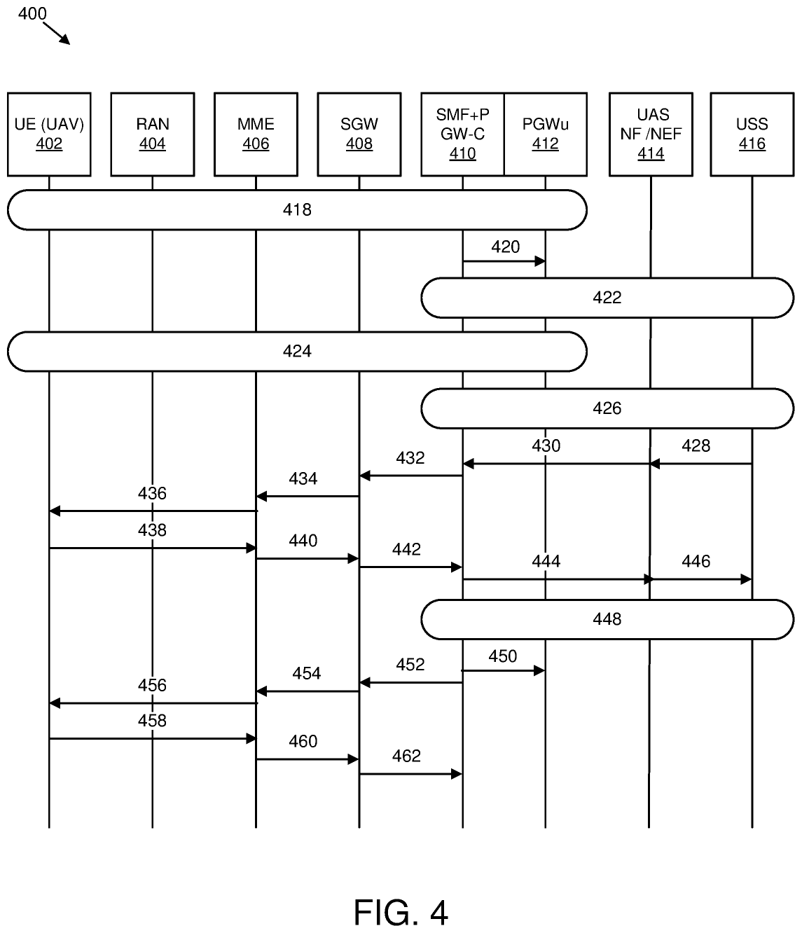

FIG. 4 is a schematic block diagram illustrating one embodiment of a system 400 in which there is UUAA during PDN connection establishment at an attach procedure in EPS. The system 400 includes a UE 402 (e.g., UAV), a RAN 404, an MME 406, an SGW 408, an SMF+P GW-C 410, a PGWu 412, a UAS NF/network exposure function (“NEF”) 414, and a USS 416. In a first communication 418, a first portion of an attach procedure is performed. In a second communication 420, there is an optional ACL configuration. In a third communication 422, optional communication steps are performed. In a fourth communication 424, a second portion of the attach procedure is performed. In a fifth communication 426, a sixth communication 428, and a seventh communication 430, additional optional communication steps may be performed. In an eighth communication 432 and a ninth communication 434, an optional update bearer request including PCO and/or an authentication message may be sent. In a tenth communication 436, a downlink NAS transport message including PCO and/or an authentication message may be sent.

In an eleventh communication 438, an uplink NAS transport message including PCO and/or an authentication message may be sent. In a twelfth communication 440 and a thirteenth communication 442, an optional update bearer response including PCO and/or an authentication message may be sent. In a fourteenth communication 444, a fifteenth communication 446, and sixteenth communication 448, further optional communication steps may be performed. In a seventeenth communication 450, an optional update ACL message may be sent. In an eighteenth communication 452 and a nineteenth communication 454, an optional update bearer request including PCO with an indication that the uplink data allowed message may be sent. In a twentieth communication 456, a downlink NAS transport message including PCO with an indication that uplink data allowed message may be sent. In a twenty-first communication 458, an uplink NAS transport message including PCO may be sent. In a twenty-second communication 460 and a twenty-third communication 462, an optional update bearer response including PCO message may be sent.

Attach procedures in 3GPP may describe how a UE, due to always-on connectivity for UE of the EPS, establishes a default EPS bearer during network attachment. Although PDN connectivity as such is an option in 3GPP, the UAS specification 3GPP may mandate the UUAA during that PDN connection establishment in EPS during the attach procedure and the corresponding PDN connection establishment. The network may support UUAA during PDN connection establishment. The UAV may support UUAA during PDN connection establishment procedure.

During that the PDN connectivity and the UUAA, the UE may be required to transmits the following information which may include: 1) a CAA-Level UAV ID of a UAV; a USS address; and a UUAA aviation payload.

If the UE is also considering the PDN connection for C2 communications, the UE may additionally transmit the following information which includes: 1) a UAS container including UAV UAV-C pairing information; and 2) flight authorization information.

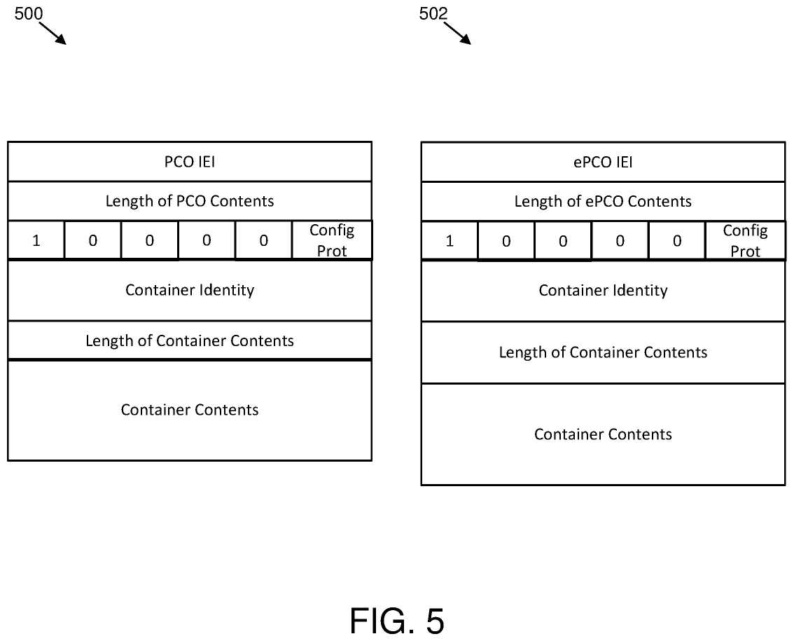

In some embodiments, a UE is to transmit information within a PCO information element (“IE”) or an ePCO IE towards a network. Therefore, the PCO IE with 2\hat{ }=256 octets as well as the ePCO IE with 2\hat{ }=65,536 octets as shown in FIG. 5 and are defined in 3GPP and may be used to convey data between the UE and the PDN GW which also has SMF functionality and further the USS server.

FIG. 5 is a schematic block diagram illustrating one embodiment of a PCO IE 500 and an ePCO IE 502.

In various embodiments, the 3GPP has made the decision that communications between the UE and the USS server must not have any impact on MME.

In certain embodiments, if the MME supports NB-S1 mode, Non-IP or Ethernet PDN type, inter-system change with 5GS or the network may enforce the use of domain name system (“DNS”) over traffic layer security (“TLS”), then the MME may support the extended protocol configuration options IE.

In some embodiments, an MME, SGW and PGW which supports NB-IoT and/or Non-IP or Ethernet PDN type and/or inter-system change with 5GS may support ePCO. A UE supporting NB-IoT access and/or Non-IP or Ethernet PDN type and/or N1 mode also support ePCO.

In various embodiments, there is no requirement that the MME or SGW support an inter-system change with 5GS. In certain embodiments, an EPS UE without capability for 5GS must be able to have UAS services. For EPC, the PDN connections used by UAV are served by SMF+PGW-C regardless of whether the UAV support 5G NAS or whether their subscription allows access to 5GC. The APN(s) used by the UAV for contacting USS or for C2 communication always resolves to a SMF+PGW-C.

In some embodiments, it is not clear that the serving GW or the MME supports ePCO IE, and if one of them is not compatible with ePCO IE, then the communication must happen based on PCO IE.

In various embodiments described herein, the following problems may be solved: 1) how does a UE at time of attach knows that MME supports ePCO; 2) how the MME makes sure that SGW and PGW are compatible for intersystem change with 5GS, since there is no requirement for the UE to support the 5GS signaling; 3) how to make UAS services work if an MME or serving GW are not compatible with the ePCO IE; and/or 4) since the information for UUAA aviation payload, UAV-C pairing, and flight authorization are outside the scope of the 3GPP, can the maximum size of ePCO contents be adequate for data transportation, and if not, then what is to be done.

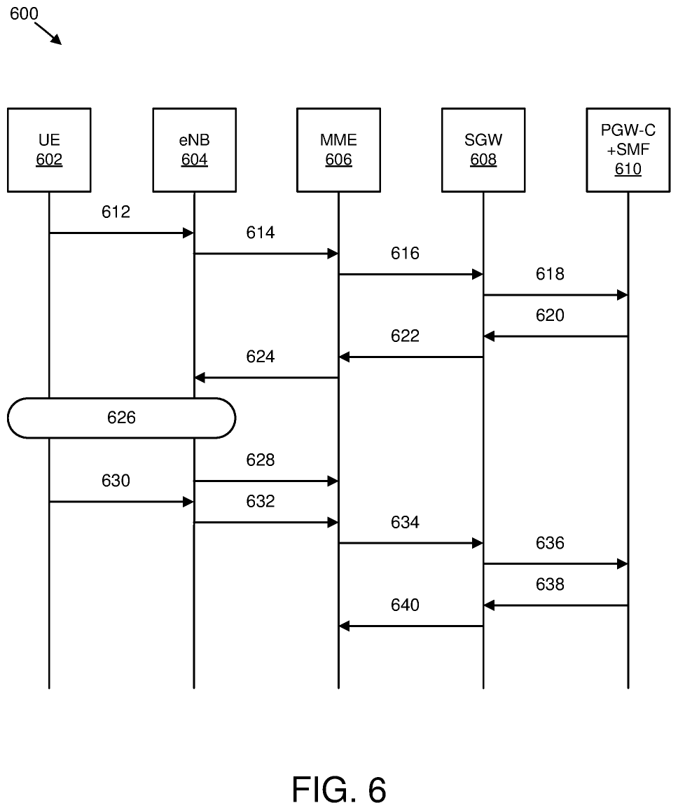

In certain embodiments, as described in 3GPP, the attach procedure is used by a UE to attach an EPC for packet services in the EPS. As it is required for the UE to perform the UUAA for the UAS services, the UE may establish a PDN connection at the time of attach according to FIG. 6.

FIG. 6 is a schematic block diagram illustrating one embodiment of a system 600 for UUAA and C2 authorization at PDN connection establishment when attaching to EPS. The system 600 includes a UE 602, an eNB 604, an MME 606, an SGW 608, and a PGW-C+SMF 610 (e.g., PDN GW).

In a first communication 612, there may be a radio resource control (“RRC”) request (e.g., attach request) transmitted. The UE 602 initiates the attach procedure by sending an attach request including: 1) a UE 602 network capability IE with the bit set to indicate support for an ePCO IE; and 2) a PDN connectivity request message contained in an EPS session management (“ESM”) message container IE.

The PDN connectivity request message includes a PCO IE with a length of one octet. The PCO is chosen since the UE 602 is not aware if the network supports the extended PCO. In certain embodiments, during PDN connectivity and UUAA, the UE may transmit the following information: 1) a CAA-Level UAV ID of a UAV; 2) a USS address; and/or 3) a UUAA aviation payload.

Furthermore, if the UE also considers authorization for C2 communications, the UE may additionally transmit the following information: 1) a UAS container including UAV UAV-C pairing information; and flight authorization information.

Since the transmitted information may be larger than a size of a PCO container contents, the UE may only insert: 1) the CAA-Level UAV ID of the UAV; 2) the USS address if there is enough space for the USS address and if it is needed; 3) a segment number indicating a number of current pieces of information for UUAA and possible C2 authorization; and/or 4) an indicator that there is more data for the UUAA and possibly authorization for C2 communications. In some embodiments, an upper layer makes a determination if the UE is required to insert the USS address. However, it there is no space for the USS address, the UE does not include that information.

In various embodiments, a UE may use a service-level-authorization and authentication (“AA”) container IE. In such embodiments, if a network, such as the PGW-C+SMF 610, supports the UAS services, then the service-level-AA container IE may be interpreted by the network as an identifier that the UE is establishing a PDN connection for UAS services. The indicator may also indicate to the PGW-C+SMF 610 not to reject the initial request due to shortage of data for UUAA and possible C2 authorization. In certain embodiments, a UE uses an RRC request message including an attach request transmitted to the network for an RRC connection.

In a second communication 614, an initial UE message (e.g., including the attach request) may be transmitted. Specifically, upon receipt by the eNB 604, the eNB 604 may select the MME 606 from the RRC request message carrying the old globally unique mobility management entity identifier (“GUMMEI”) including a PLMN identity, an MME group identity, and an MME code where the MME code may be used by the NAS node selection function of the eNB 604 to select the MME 606. If the MME is not associated with the eNB 604 or the old GUMMEI is not available, the eNB 604 selects an MME 606 in a predefined manner. Moreover, the eNB 604 makes selection of the MME 606 based on the GUMMEI with or without distinguishing on whether there is a mapping from packet temporary mobile subscriber identity (“P-TMSI”) and/or routing area identity (“RAI”) or whether there is a native GUMMEI. If a dedicated core network (“DCN”) is deployed and the UE assisted DCN selection feature is supported, the UE 602 may provide DCN-ID to the eNB 604 to be used for MME 606 selection. If UE assisted DCN selection feature is supported and a DCN-ID is provided by the UE, the DCN-ID may be used in the eNB 604 for MME 606 selection to maintain the same DCN when the serving MME 606 is not available.

In a third communication 616, a create session request message may be transmitted. The MME 606 may use the UE's globally unique temporary identity (“GUTI”) received from the UE 602 and if the MME 606 has not been changed since the last detach to verify the UE's identity. If the MME 606 has been changed since the last detach, the MME 606 uses the GUTI received from the UE 602 to derive the old MME and/or serving general packet radio service (“GPRS”) support node (“SGSN”) address to request for the UE's identity and any UE context. If the UE 602 is unknown, the MME 606 request for the UE's international mobile subscriber identity (“IMSI”) and the network may authenticate the UE 602. The MME 606 selects the SGW 608 based on network topology (e.g., the selected Serving GW serves the UE's location and for overlapping SGW 608 service areas, the selection may prefer serving GWs with service areas that reduce the probability of changing the serving GW).

Since the request type is an “initial request”, if the UE 602 has not provided any APN and the subscription context from home subscriber server (“HSS”) contains the PGW-C+SMF 610 identity corresponding to the default APN, the MME 606 uses the PGW-C+SMF 610 corresponding to the default APN for default bearer activation. While, if the UE 602 provided an APN, the MME 606 selects the PGW-C+SMF 610 corresponding to the provided APN for default bearer activation.

If DCN with dedicated serving GW and PGW-C+SMF 610 is used, the DNS procedure for serving GW and PGW-C+SMF 610 selections may be used such that a serving GW and the PGW-C+SMF 610 belonging to a DCN serving the UE 602 supporting UAS services.

If the MME 606 support ePCO, extended PCO support indication is set to 1 on S11 interface by the MME 606 to inform the SGW 608 is supported by the UE 602 and MME 606 and uses a create session request message to send to the SGW 608.

The UE 602, supporting UAS services, may have included one or more APN for one or more PDN for the UAS services. The one or more PDNs are used for identifying one or more PGWs capable of UAS services in any request (e.g., initial request or handover request). The subscription context which is provided by the HSS, for the UE 602 supporting UAS services may include one or more APNs for one or more PDNs for the UAS services. The one or more PDNs are used for identifying one or more PGWs capable of UAS services. The subscription context provides which of the one or more PDNs provided by the UE are in subscription contexts and which of them are the default ones for the UE 602.

In a fourth communication 618, a crease session request message is transmitted. The SGW 608 creates a new entry in its EPS bearer context table and sends create session request message comprising APN, serving GW address, PDN address, subscribed APN, and protocol configuration options towards the PGW-C+SMF 610 indicated by the PGW-C+SMF 610 address received in the previous step. The SGW 608 buffer any data downlink packets it may receive from the PGW-C+SMF 610 until it receives modify bearer request message from the MME 606. If the SGW 608 supports ePCO, the SGW 608 sets extended PCO support indication to 1 on S5/S8 interface to show the support for ePCO by the UE 602, MME 606, and SGW 608 to the PGW-C+SMF 610.

In a fifth communication 620, a create session response message is transmitted. The PGW-C+SMF 610 receives the create session request message including the PCO IE which includes: 1) the CAA-Level UAV ID of the UAV; 2) the USS address if there is enough space for the USS address and if it is needed; 3) the segment number; and 4) an indicator that there is more data to come for the UUAA and possibly authorization for C2 communications. The PGW-C+SMF 610 buffers the received information and creates a new entry in its EPS bearer context table and returns. The create session response message includes the PGW-C+SMF 610 address for the user plane, PDN address, and ePCO support or PCO support and is sent towards the SGW 608.

In a sixth communication 622, the create session response message is transmitted. The SGW 608 returns the create session response message to the MME 606 including the ePCO or PCO support.

In a seventh communication 624, the MME 606 sends to the eNB 604 an attach accept message including a session management request message used to establish a PDN connection which may be an ESM message container including: 1) the activate default eps bearer context request message; and 2) the EPS network feature support includes ePCO or PCO support for the network. The attach accept request is transmitted within an S1AP initial context setup request message.

In an eight communication 626, upon the eNB 604 receiving the S1AP initial context setup request, the eNB 604 sends an RRC connection reconfiguration message including the attach accept message including ePCO support to the UE 602.

In a ninth communication 628, the UE 602, upon receipt of the RRC connection reconfiguration message, sends the RRC connection reconfiguration complete message to the eNB 604 which may trigger the eNB 604 transmitting initial context setup response message to the MME.

In a tenth communication 630, the UE may send a direct transfer message to the eNB 604, including the attach complete message including the activate default eps bearer context accept message contained in the ESM message container IE.

In an eleventh communication 632, the eNB 604 may use an uplink NAS transport message to send the attach complete to the MME 606.

In a twelfth communication 634, the MME 606 may use a modify bearer request message to send the ePCO content including information or UUAA and possibly authorization for C2 communications and the indicator that there is no more data to the SGW 608.

In a thirteenth communication 636, the SGW 608 may use a modify bearer request message to send the ePCO content including information or UUAA and possibly authorization for C2 communications and the indicator that there is no more data to the PDN WG 610.

In a fourteenth communication 638 and a fifteenth communication 640, modified bearer response messages may be sent.

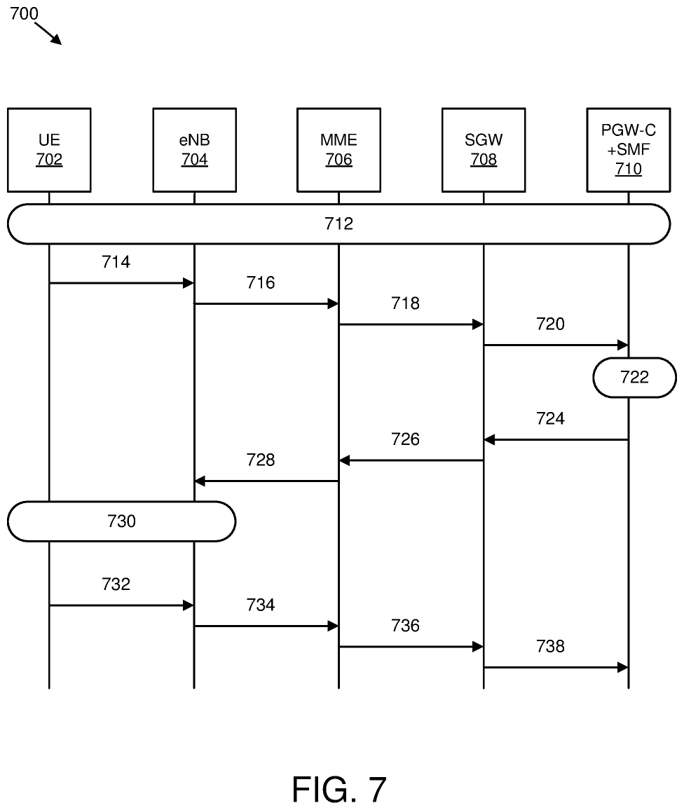

In a first embodiment, there may be UUAA and authorization for C2 communications. In such an embodiment, a UE acts in a similar way as in a UE requested bearer resource allocation procedure or a UE requested bearer resource modification procedure. One version of the first embodiment is illustrated in FIG. 7.

FIG. 7 is a schematic block diagram illustrating one embodiment of a system 700 for UE initiated completion of data for UUAA and possible C2 authorization. The system 700 includes a UE 702, an eNB 704, an MME 706, an SGW 708, and a PGW-C+SMF 710 (e.g., PDN GW).

In a first communication 712, an attach procedure may be performed.

In a second communication 714, an RRC request may be sent (e.g., bearer resource modification message). The UE 702 may be aware whether the ePCO is supported by the network.

For network supported ePCO, if the ePCO is supported, the UE 702 includes extended protocol configuration options in a bearer resource modification request message includes the remaining information such as: 1) the CAA-Level UAV ID of the UAV; 2) the USS address; and/or 3) the UUAA aviation payload.

If the UE 702 considers authorization for the C2 communications, the UE 702 may additionally transmit the following information: 1) the UAS container including UAV UAV-C pairing information; and/or 2) the flight authorization information. The UE 702 can send all the information instead of sending the remainder of the information to make sure that the PGW-C+SMF 710 has enough information to perform UUAA and possibly authorization for C2 communications.

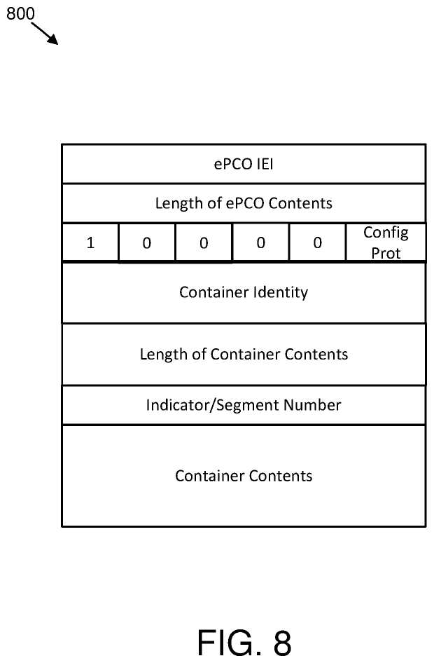

If one ePCO is enough to send all the required information for UUAA and possible C2 authorization, the UE 702 may also add an indicator that there is no more data to come for the UUAA and possibly authorization for C2 communications. If one ePCO is not enough, the UE 702 may set that indicator to a value indicating that there is more data and information to come. The UE 702 can proceed with segmentation for the case the ePCO is not supported by having a first octet in a container including a segment number as shown in FIG. 8. Specifically, FIG. 8 is a schematic block diagram illustrating one embodiment of a system 800 for a container for ePCO.

Returning to FIG. 7, if the ePCO is not supported by the network and the UE 702 needs to send more information than CAA-level UAV ID that has already been sent for UUAA, the UE 702 may segment the remainder of the information which includes: 1) the USS address; 2) the UUAA aviation payload; 3) the UAS container including UAV UAV-C pairing information; and/or 4) the flight authorization information.

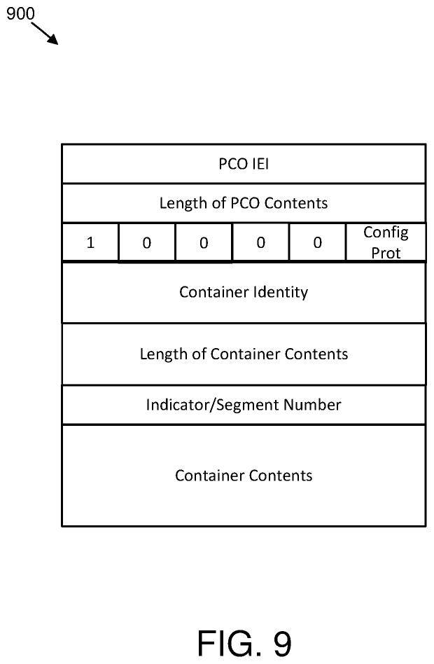

If the UE 702 also considers authorization for the C2 communications, with a segment size which can be fit in the contents of the container identifier with the length of one octet, the UE 702 may insert each segment in the container contents. The segment for the USS address may be less than a length of PCO container contents shown in FIG. 9. Specifically, FIG. 9 is a schematic block diagram illustrating one embodiment of a system 900 for a container for PCO. However, the information elements may include information such as: 1) the UUAA aviation payload; 2) the UAS container comprising UAV UAV-C pairing information; and/or 3) the flight authorization information which may be larger than a length of PCO container contents in FIG. 5 and the segment number may be the first octet in the container contents.

Returning to FIG. 7, the UE 702 may then create as many containers as number of the segments with the same container identity identifying the information for UUAA and possible C2 authorization. The required information for UAS services is identified by the service-level-AA container IE. Therefore, the container identity may identify the service-level-AA container IE. All these containers identified for being for the UUAA and possible C2 authorization may then be inserted one by one in order of segment as a PCO; each time in a new bearer resource modification request message targeted to the PGW-C+SMF 710 and is transmitted towards the eNB 704 in an RRC message. It should be noted that communications 714 through 720 in FIG. 7 may be repeated for each transmitted segment.

In a third communication 716, the eNB 704 may use an uplink NAS transport message to send a bearer resource modification request message to the MME 706.

In a fourth communication 718, upon receipt of the uplink NAS transport message, the MME 706 constructs a bearer resource command including ePCO or PCO and forwards towards the SGW 708.

In a fifth communication 720, the SGW 708 forwards the bearer resource command towards the PGW-C+SMF 710.

The PGW-C+SMF 710 uses 722 the information received in ePCO or PCO and may buffer with any previous information. The buffering may be done with respect to the segment number received in ePCO or PCO. If the indicator indicates there is no more data to come, the PGW-C+SMF 710 may have the entire list below for UUAA: 1) the CAA-Level UAV ID of the UAV; 2) the USS address; and/or 3) the UUAA aviation payload. For authorization for the C2 communications: 1) the UAS container including UAV UAV-C pairing information; and 2) the flight authorization information.

In a sixth communication 724, the PGW-C+SMF 710 after successful UAV UUAA and authorization for C2 communications may send information to the UE 702. For the successful UUAA: 1) the successful result of the authorization; 2) a new CAA level UAV ID; and 3) the UUAA authorization payload. For authorization for C2 communications: 1) successful result for C2 authorization; 2) C2 session security information; 3) a new CAA level UAV ID; and 4) flight authorization information. If the PGW-C+SMF 710 has not received all required information for UUAA and/or C2 authorization from the UE 702 so that the indicator says that there is more data to come, the PGW-C+SMF 710 may still follow this procedure by including the unsuccessful result for UUAA and C2 authorization.

If the ePCO is supported by the network and all the information can be fit in one ePCO, the PGW-C+SMF 710 includes extended protocol configuration options in an update bearer request including: 1) the successful result of the authorization; 2) a new CAA level UAV ID; and 3) UUAA authorization payload. The request may also include authorization for C2 communications including: 1) successful result for C2 authorization; 2) C2 session security information; 3) a new CAA level UAV ID; and 4) flight authorization information. It should be noted that new CAA level UAV ID is not added twice if both results for UUAA and C2 authorization are to be sent. However, the result of UUAA and authorization for C2 authorization may be sent at different times and the new CAA level ID may be sent by both results.

If one ePCO is enough to send all the required information for successful result of UUAA and possible C2 authorization, the PGW-C+SMF 710 may also additionally add an indicator that there is no more data to come as the result for the UUAA and possibly authorization for C2 communications. If one ePCO is not enough, the PGW-C+SMF 710 may set that indicator to a value that there is more data and information to come. The PGW-C+SMF 710 can proceed with segmentation as described in this context, by having the first octet in the container contents for segment number.

If the ePCO is not supported by the network or the UE, the PGW-C+SMF 710 may employ the segmentations with numbering of the UUAA result and result for possible C2 authorization to create multiple containers identified by the service-level-AA container IE as described in context and transmitting one by one in order of segment number as PCO, each time in a new update bearer request message targeted the UE 702, and is transmitted towards the SGW 708. It should be noted that communications 724 through 738 in FIG. 7 may be repeated for each transmitted segment.

If the SMF+PGW-C 710 (e.g., PDN GW) uses the first segment of information which contains CAA-level UAV ID to send to a USS for authentication even if the UE 702 indicates there is more data to come, the network may authenticate the UE 702 based on that information even if the UE 702 has indicated to send more data.

In a seventh communication 726, the SGW 708 forwards the update bearer request message to the MME 706.

In an eighth communication 728, the MME 706 uses a downlink NAS transport message and includes a modify EPS bearer context request message including the ePCO or PCO to forward the message towards the eNB 704.

In a ninth communication 730, upon the eNB 704 receiving the downlink NAS transport request, the eNB 704 and the UE 702 perform RRC connection reconfiguration by exchanging RRC connection reconfiguration messages including a modify EPS bearer context request message and an RRC connection reconfiguration complete message.

In a tenth communication 732, the UE 702 may send a direct transfer message to the eNB 704 including the modify EPS bearer context accept message to the eNB 704.

In an eleventh communication 734, the eNB 704 uses an uplink NAS transport to covey the modify EPS bearer context accept message to the MME 706.

In a twelfth communication 736, the MME 706 constructs an update bearer response message and transmit it to the SGW 708 to acknowledge.

In a thirteenth communication 738, the SGW 708 sends the acknowledgement towards the PGW-C+SMF 710.

In a second embodiment, there may be a re-UUAA.

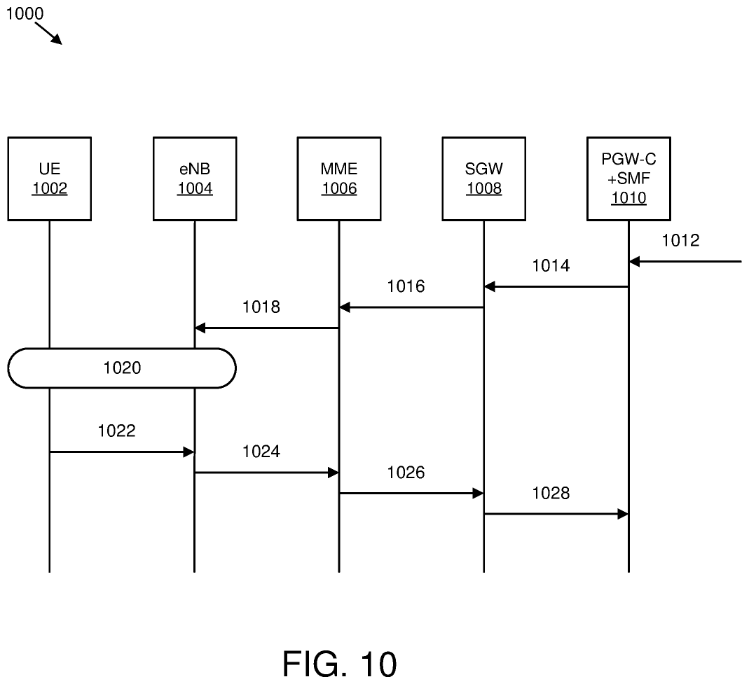

FIG. 10 is a schematic block diagram illustrating one embodiment of a system 1000 for network initiated completion of data for re-UUAA. The system 1000 includes a UE 1002, an eNB 1004, an MME 1006, an SGW 1008, and a PGW-C+SMF 1010 (e.g., PDN GW). In FIG. 10, the communications 1014 through 1028 as shown in FIG. 10 may be substantially similar to corresponding communications 724 through 738 in FIG. 7.

Further, the PGW-C+SMF 1010 receives 1012 a request for re-UUAA of the UE 1002 including the UE's authentication context. The PGW-C+SMF 1010 after a successful UUAA may transmit the following to the SGW in communication 1014: 1) a successful result of the authorization; 2) a new CAA level UAV ID; and/or 3) a UUAA authorization payload.

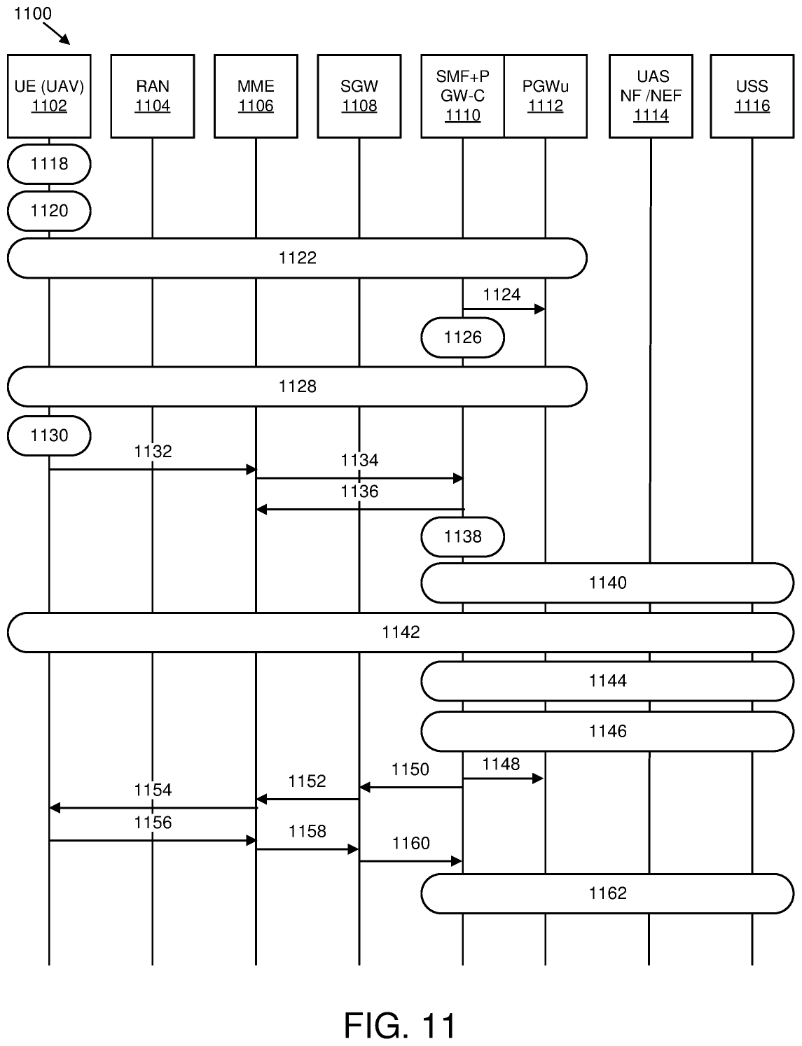

In a third embodiment, there may be UUAA and authorization for C2 communications. In the third embodiment, an attach procedure is used by a UE to attach an EPC for packet services in the EPS. As it is required for the UE to perform the UUAA for the UAS services, the UE may establish a PDN connection at the time of attach according to FIG. 11.

FIG. 11 is a schematic block diagram illustrating one embodiment of a system 1100 for UUAA and C2 authorization at PDN connection establishment when attaching to EPS. The system 1100 includes a UE 1102 (e.g., UAV), a RAN 1104, an MME 1106, an SGW 1108, an SMF+P GW-C 1110, a PGWu 1112, a UAS NF/NEF 1114, and a USS 1116.

An application in the UE 1102 provides 1118 payload data for UUAA and optionally C2 to the UE 1102.

The UE 1102 determines 1120 that payload data cannot fit in a PCO in an attach request+PDN connectivity request.

In a first communication 1122, the UE 1102 initiates an attach procedure by sending an attach request including: 1) a UE network capability IE with the bit set to indicate the support for the ePCO IE; and 2) a PDN connectivity request message contained in the ESM message container IE.

The PDN connectivity request message includes PCO IE with a length one octet. The PCO is chosen since the UE 1102 is not aware if the network supports the extended PCO. During PDN connectivity and UUAA, the UE 1102 may transmit the following information which may include: 1) the CAA-Level UAV ID of the UAV; 2) the USS address; and/or 3) the UUAA aviation payload.

Furthermore, if the UE 1102 also considers authorization for C2 communications, the UE 1102 is to additionally transmit the following information: 1) the UAS container including UAV UAV-C pairing information; and 2) the flight authorization information.

In certain embodiments, since the information may be larger than the size of the PCO container contents, the UE 1102 may only insert: 1) the CAA-Level UAV ID of the UAV; 2) the USS address if there is enough space and it's needed; 3) a segment number indicating the number of a current piece of information for UUAA and possible C2 authorization; and 4) an indicator that there is more data for the UUAA and possibly authorization for C2 communications. It should be noted that the upper layer makes the determination if the UE 1102 is required to insert the USS address. However, it there is no space for the USS address, the UE 1102 does not include that information.

The UE 1102 may use the service-level-AA container IE. If the network, such as PDN GW, supports the UAS services, the service-level-AA container IE may be interpreted by the network as an identifier that the UE 1102 is establishing a PDN connection for UAS services. The indicator may also indicate to the PDN GW not to reject the initial request due to shortage of data for UUAA and possible C2 authorization. The UE 1102 uses the RRC request message including the attach request to the network for an RRC connection.

In a second communication 1124, the SMF+PGW-C 1110 provides default ACL to the PGWu 1112.

The SMF+PGW-C 1110 receives 1126 a create session request message including the PCO IE including the UAV provided information, such as: 1) the CAA-Level UAV ID of the UAV; 2) the USS address if there is enough space and it is needed; 3) the segment number; and/or 4) an indicator that there is more data to come for the UUAA and possibly authorization for C2 communications.

The SMF+PGW-C 1110 determines based on the indicator that the UAV did not provide all required data and allow PDN connectivity request to continue but does not start authentication with the USS. The PDN GW buffers the received information and creates a new entry in its EPS bearer context table and returns. The create session response message includes a PDN GW address for the user plane, PDN address, and ePCO support or PCO support and is sent towards the SGW 1108.

In a third communication 1128, the attach procedure continues. The SGW 1108 returns a create session response message to the MME 1106 including the ePCO or PCO support. The MME 1106 sends, to an eNB, an attach accept message including a session management request message used to establish a PDN connection which may be an ESM message container including: 1) an activate default eps bearer context request message; and 2) the EPS network feature support includes ePCO or PCO support for the network. The attach accept request is transmitted within an S1AP initial context setup request message.

The UE 1102 includes 1130 the additional payload for UUAA and C2.

In a fourth communication 1132, the UE 1102 sends a direct transfer message to the eNB, including the attach complete message including the activate default eps bearer context accept message contained in the ESM message container IE. In the PCO and/or ePCO, the UE 1102 indicates whether all data has been provided.

In a fifth communication 1134, the MME 1106 may use a modify bearer request message to send the ePCO content including information or UUAA and possibly authorization for C2 communications and the indicator that there is no more data.

In a sixth communication 1136, the SMF+PGW-C 1110 responds with a modify bearer response.

Based on the indicator that all data is available, the SMF+PGW-C 1110 starts 1138 the authentication with the USS 1116.

In a seventh communication 1140, authentication is performed via a UAS NF/NEF 1114.

In an eighth communication 1142, the USS 1116 and the UE 1102 exchange additional authentication information.

In a ninth communication 1144, the UUAA procedure continues.

In a tenth communication 1146, if the authentication and/or authorization is successful, the USS 1116 may subscribe to the PDN connection status event. The UAS NF/NEF 1114 may use the APN and/or data network name (“DNN”) received from the SMF+PGW-C 1110 to subscribe to the PDN connection status event notification.

In an eleventh communication 1148, if the UUAA is successful, the SMF+PGW-C 1110 contacts the PCF to update the PDN connection. Then the SMF+PGW-C 1110 updates the access control list (“ACL”) and policies in the UPF+PGW-U to allow traffic over the default PDN connection. If a DN authorization profile index was received from the UAS NF/NEF 1114 SMF+PGW-C 1110, the SMF+PGW-C 1110 includes that when retrieving the ACL from the PCF. If the SMF receives the DN authorized session aggregate maximum bit rate (“AMBR”) from the UAS NF/NEF 1114, it sends the DN authorized session AMBR within the session AMBR to the PCF to retrieve the authorized session AMBR.

In communications 1150 through 1160, the PCO includes an indication that uplink data is allowed, the UUAA aviation payload (e.g., the authentication and/or authorization result and the authorization data), is transferred from the SMF+PGW-C 1110 to the UE 1002 in an update bearer request and downlink NAS transport. The UE 1102 (for the UAV) confirms the update.

In communication 1162, if the USS subscribed to the PDN connection status event, the SMF+PGW-C 1110 will detect when the PDN connection is established and send the PDN connection establishment event report to the UAS NF/NEF 1114 by means of a Nsmf_EventExposure Notify message including a general public subscription identifier (“GPSI”) and the UE IP address. Then the UAS NF/NEF 1114 forwards the event message to the USS 1116.

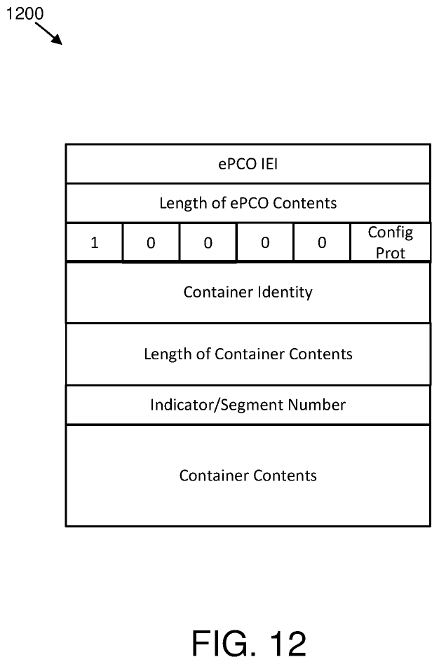

If one ePCO is enough to send all the required information for UUAA and possible C2 authorization, the UE 1102 may also add an indicator that there is no more data to come for the UUAA and possibly authorization for C2 communications. If one ePCO is not enough, the UE 1102 may set that indicator to a value that there is more data and information to come. The UE 1102 may proceed with segmentation if ePCO is not supported, by having the first octet in the container contents for a segment number as shown in FIG. 12.

Specifically, FIG. 12 is a schematic block diagram illustrating one embodiment of a system 1200 with a container for ePCO.

If the ePCO is not supported by the network and the UE needs to send more information than CAA-level UAV ID that has already been sent for UUAA, the UE may segment the remainder of the information which includes: 1) the USS address; 2) the UAS container including UAV UAV-C pairing information; and 3) the flight authorization information.

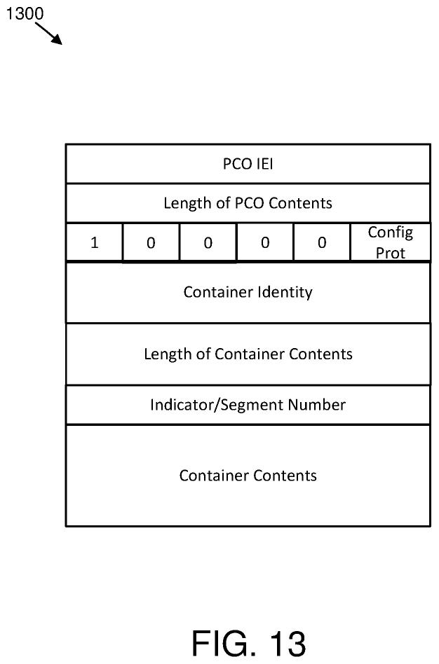

If the UE is also considering authorization for the C2 communications, with the segment size which can fit in the contents of the container identifier with the length of one octet, the UE may insert each segment in the container contents. The segment for the USS address may be less than a length of PCO container contents. However, the IE may include information such as: 1) the UAS container including UAV UAV-C pairing information; and/or 2) the flight authorization information. The container may be larger than a length of PCO container contents may be numbered as shown in FIG. 13, where the segment number may be the first octet in the container contents.

FIG. 13 is a schematic block diagram illustrating one embodiment of a system 1300 with a container for PCO.

The UE may then create as many containers as number of the segments with the same container identity identifying the information for UUAA and possible C2 authorization. The required information for UAS services is identified by the service-level-AA container IE. Therefore, the container identity may identify the service-level-AA container IE. All these containers identified for the UUAA and possible C2 authorization may then be inserted one by one in order of segment as a PCO; each time in a new bearer resource modification request message targeted the PDN GW and is transmitted towards the eNB in an RRC message.

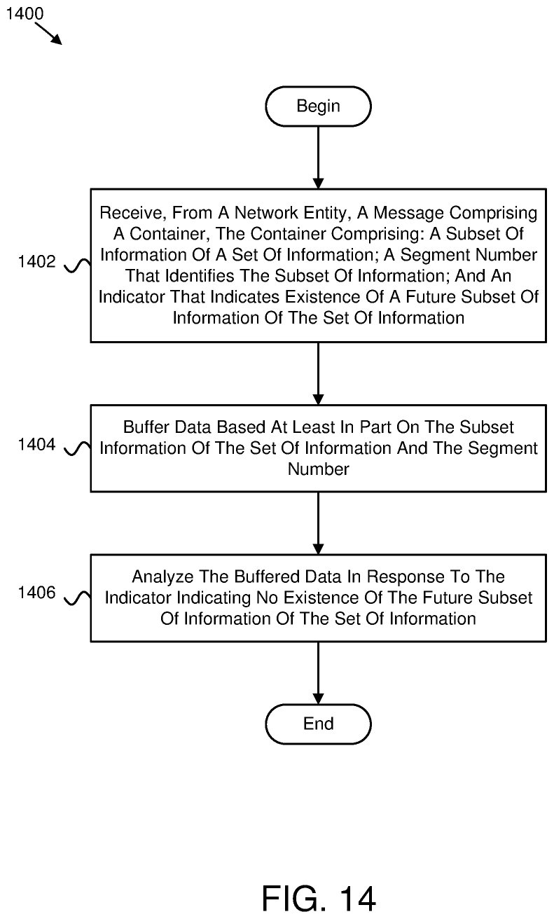

FIG. 14 is a flow chart diagram illustrating one embodiment of a method 1400 for configuring buffering based on information in a container. In some embodiments, the method 1400 is performed by an apparatus, such as the network unit 104. In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes receiving 1402, at a device, from a network entity, a message including a container, the container including: a subset of information of a set of information; a segment number that identifies the subset of information; and an indicator that indicates existence of a future subset of information of the set of information. In some embodiments, the method 1400 includes buffering 1404 data based at least in part on the subset information of the set of information and the segment number. In certain embodiments, the method 1400 includes analyzing 1406 the buffered data in response to the indicator indicating no existence of the future subset of information of the set of information.

In certain embodiments, the network entity comprises a PDN GW. In some embodiments, the network entity further comprises a SMF. In various embodiments, the buffered data comprises: a result for an UUAA; a UAV ID of a UAV; a UUAA authorization payload; or a combination thereof.

In one embodiment, the buffered data comprises: a result for authorization of C2 communications; C2 session security information; an UAV ID of a UAV; flight authorization information; or a combination thereof. In certain embodiments, the method 1400 further comprises, to analyze the buffered data, determining that the device has an authorization for USS services, an UAV ID, a UUAA authorization payload, or a combination thereof. In some embodiments, the method 1400 further comprises, to analyze the buffered data, determining that the apparatus has an authorization for C2 communications, an UAV ID, a C2 session security information, flight authorization information, or a combination thereof.

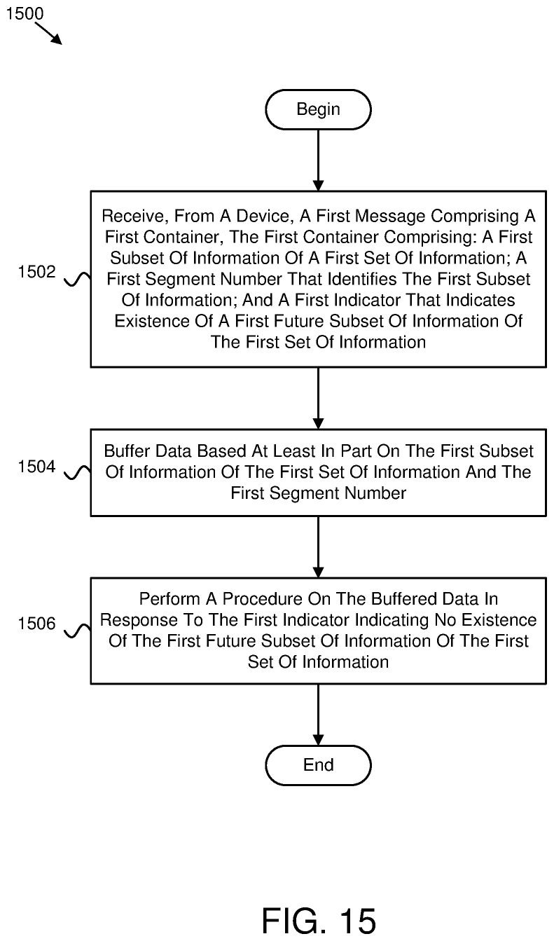

FIG. 15 is a flow chart diagram illustrating another embodiment of a method 1500 for configuring buffering based on information in a container. In some embodiments, the method 1500 is performed by an apparatus, such as the network unit 104. In certain embodiments, the method 1500 may be performed by a processor executing program code, for example, a microcontroller, a microprocessor, a CPU, a GPU, an auxiliary processing unit, a FPGA, or the like.

In various embodiments, the method 1500 includes receiving 1502, at a first network entity, from a device, a first message comprising a first container, the first container including: a first subset of information of a first set of information; a first segment number that identifies the first subset of information; and a first indicator that indicates existence of a first future subset of information of the first set of information. In some embodiments, the method 1500 includes buffering 1504 data based at least in part on the first subset of information of the first set of information and the first segment number. In certain embodiments, the method 1500 includes performing 1506 a procedure on the buffered data in response to the first indicator indicating no existence of the first future subset of information of the first set of information.

In certain embodiments, the method 1500 further comprises transmitting, to the device, a second message comprising a second container, the second container comprising: a second subset of information of a second set of information; a second segment number that identifies the second subset of information; and a second indicator that indicates existence of a second future subset of information of the second set of information. In some embodiments, the first network entity comprises a PDN GW. In various embodiments, the first network entity further comprises a SMF.

In one embodiment, a second network entity performs the procedure on the buffered data, and the second network entity comprises an USS server. In certain embodiments, the procedure comprises: an UUAA; C2 authorization for C2 communications; or a combination thereof.

In some embodiments, the buffered data comprises: an UAV ID of a UAV; an USS address; a USS server UUAA aviation payload; or a combination thereof. In various embodiments, the buffered data comprises: an UAV ID of a UAV; an UAS container comprising UAV pairing information; flight authorization information; or a combination thereof.

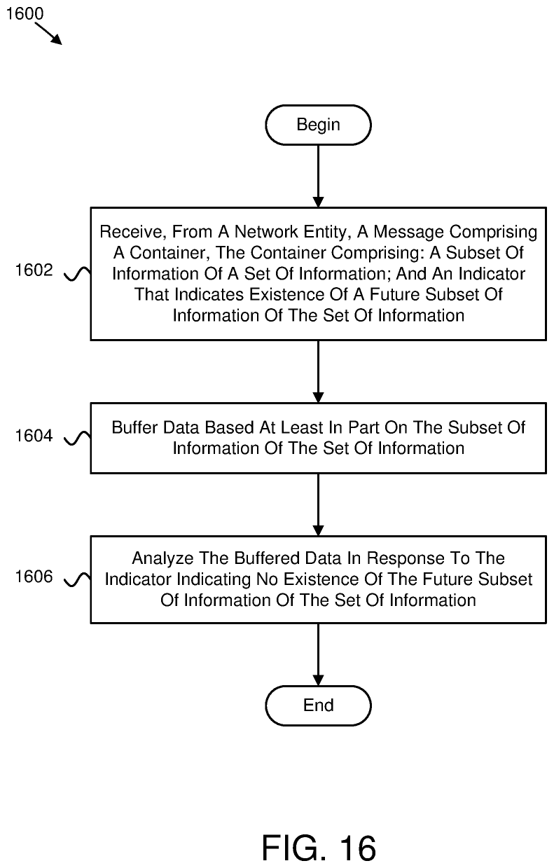

FIG. 16 is a flow chart diagram illustrating a further embodiment of a method 1600 for configuring buffering based on information in a container. In some embodiments, the method 1600 is performed by an apparatus, such as the network unit 104. In certain embodiments, the method 1600 may be performed by a processor executing program code, for example, a microcontroller, a microprocessor, a CPU, a GPU, an auxiliary processing unit, a FPGA, or the like.

In various embodiments, the method 1600 includes receiving 1602, at a device, from a network entity, a message including a container, the container including: a subset of information of a set of information; and an indicator that indicates existence of a future subset of information of the set of information. In some embodiments, the method 1600 includes buffering 1604 data based at least in part on the subset of information of the set of information. In certain embodiments, the method 1600 includes analyzing 1606 the buffered data in response to the indicator indicating no existence of the future subset of information of the set of information.

In certain embodiments, the container further comprises a segment number that identifies the subset of information, and the buffered data is buffered based on the segment number. In some embodiments, the network entity comprises a PDN GW. In various embodiments, the network entity is co-located with a SMF.

In one embodiment, the buffered data comprises: a result for an USS server UUAA; a UAV ID of a UAV; a UUAA authorization payload; or a combination thereof. In certain embodiments, the buffered data comprises: a result for authorization of C2 communications; C2 session security information; an UAV ID of a UAV; flight authorization information; or a combination thereof.

In some embodiments, the method 1600 further comprises, to analyze the buffered data, determining that the apparatus has an authorization for USS services, an UAV ID, a UUAA authorization payload, or a combination thereof. In various embodiments, the method 1600 further comprises, to analyze the buffered data, determining that the apparatus has an authorization for C2 communications, an UAV ID, a C2 session security information, flight authorization information, or a combination thereof.

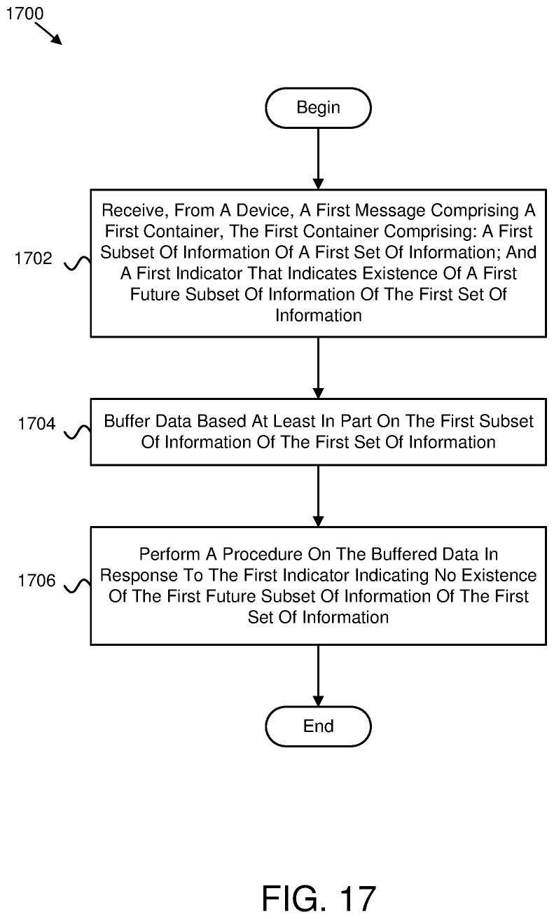

FIG. 17 is a flow chart diagram illustrating yet another embodiment of a method 1700 for configuring buffering based on information in a container. In some embodiments, the method 1700 is performed by an apparatus, such as the network unit 104. In certain embodiments, the method 1700 may be performed by a processor executing program code, for example, a microcontroller, a microprocessor, a CPU, a GPU, an auxiliary processing unit, a FPGA, or the like.

In various embodiments, the method 1700 includes receiving 1702, at a first network entity, from a device, a first message including a first container, the first container including: a first subset of information of a first set of information; and a first indicator that indicates existence of a first future subset of information of the first set of information. In some embodiments, the method 1700 includes buffering 1704 data based at least in part on the first subset of information of the first set of information. In certain embodiments, the method 1700 includes performing 1706 a procedure on the buffered data in response to the first indicator indicating no existence of the first future subset of information of the first set of information.

In certain embodiments, the first container further comprises a first segment number that identifies the first subset of information, and the buffered data is buffered based on the first segment number. In some embodiments, the method 1700 further comprises transmitting, to the device, a second message comprising a second container, the second container comprising: a second subset of information of a second set of information; and a second indicator that indicates existence of a second future subset of information of the second set of information. In various embodiments, the second container further comprises a second segment number that indicates the second subset of information.

In one embodiment, the first network entity comprises a PDN GW. In certain embodiments, the first network entity is co-located with a SMF. In some embodiments, a second network entity performs the procedure on the buffered data, and the second network entity comprises an USS server.

In various embodiments, the procedure comprises: an USS server UUAA; C2 authorization for C2 communications; or a combination thereof. In one embodiment, the buffered data comprises: an UAV ID of a UAV; an USS address; a USS server UUAA aviation payload; or a combination thereof. In certain embodiments, the buffered data comprises: an UAV ID of a UAV; an UAS container comprising UAV pairing information; flight authorization information; or a combination thereof.

In one embodiment, an apparatus comprising: a processor; and a memory coupled to the processor, the processor configured to cause the apparatus to: receive, from a network entity, a message comprising a container, the container comprising: a subset of information of a set of information; a segment number that identifies the subset of information; and an indicator that indicates existence of a future subset of information of the set of information; buffer data based at least in part on the subset of information of the set of information and the segment number; and analyze the buffered data in response to the indicator indicating no existence of the future subset of information of the set of information.

In certain embodiments, the network entity comprises a PDN GW.

In some embodiments, the network entity further comprises a SMF.

In various embodiments, the buffered data comprises: a result for an UUAA; a UAV ID of a UAV; a UUAA authorization payload; or a combination thereof.

In one embodiment, the buffered data comprises: a result for authorization of C2 communications; C2 session security information; an UAV ID of a UAV; flight authorization information; or a combination thereof.

In certain embodiments, to analyze the buffered data, the processor is configured to cause the apparatus to determine that the apparatus has an authorization for USS services, an UAV ID, a UUAA authorization payload, or a combination thereof.

In some embodiments, to analyze the buffered data, the processor is configured to cause the apparatus to determine that the apparatus has an authorization for C2 communications, an UAV ID, a C2 session security information, flight authorization information, or a combination thereof.

In one embodiment, a method at a device, the method comprising: receiving, from a network entity, a message comprising a container, the container comprising: a subset of information of a set of information; a segment number that identifies the subset of information; and an indicator that indicates existence of a future subset of information of the set of information; buffering data based at least in part on the subset information of the set of information and the segment number; and analyzing the buffered data in response to the indicator indicating no existence of the future subset of information of the set of information.

In certain embodiments, the network entity comprises a PDN GW.

In some embodiments, the network entity further comprises a SMF.

In various embodiments, the buffered data comprises: a result for an UUAA; a UAV ID of a UAV; a UUAA authorization payload; or a combination thereof.

In one embodiment, the buffered data comprises: a result for authorization of C2 communications; C2 session security information; an UAV ID of a UAV; flight authorization information; or a combination thereof.

In certain embodiments, the method further comprises, to analyze the buffered data, determining that the device has an authorization for USS services, an UAV ID, a UUAA authorization payload, or a combination thereof.

In some embodiments, the method further comprises, to analyze the buffered data, determining that the apparatus has an authorization for C2 communications, an UAV ID, a C2 session security information, flight authorization information, or a combination thereof.

In one embodiment, an apparatus comprising: a processor; and a memory coupled to the processor, the processor configured to cause the apparatus to: receive, from a device, a first message comprising a first container, the first container comprising: a first subset of information of a first set of information; a first segment number that identifies the first subset of information; and a first indicator that indicates existence of a first future subset of information of the first set of information; buffer data based at least in part on the first subset of information of the first set of information and the first segment number; and perform a procedure on the buffered data in response to the first indicator indicating no existence of the first future subset of information of the first set of information.

In certain embodiments, the processor is further configured to cause the apparatus to transmit, to the device, a second message comprising a second container, the second container comprising: a second subset of information of a second set of information; a second segment number that identifies the second subset of information; and a second indicator that indicates existence of a second future subset of information of the second set of information.

In some embodiments, the apparatus comprises a PDN GW.

In various embodiments, the apparatus further comprises a SMF.

In one embodiment, a second network entity performs the procedure on the buffered data, and the second network entity comprises an USS server.

In certain embodiments, the procedure comprises: an UUAA; C2 authorization for C2 communications; or a combination thereof.

In some embodiments, the buffered data comprises: an UAV ID of a UAV; an USS address; a USS server UUAA aviation payload; or a combination thereof.

In various embodiments, the buffered data comprises: an UAV ID of a UAV; an UAS container comprising UAV pairing information; flight authorization information; or a combination thereof.

In one embodiment, a method at a first network entity, the method comprising: receiving, from a device, a first message comprising a first container, the first container comprising: a first subset of information of a first set of information; a first segment number that identifies the first subset of information; and a first indicator that indicates existence of a first future subset of information of the first set of information; buffering data based at least in part on the first subset of information of the first set of information and the first segment number; and performing a procedure on the buffered data in response to the first indicator indicating no existence of the first future subset of information of the first set of information.

In certain embodiments, the method further comprises transmitting, to the device, a second message comprising a second container, the second container comprising: a second subset of information of a second set of information; a second segment number that identifies the second subset of information; and a second indicator that indicates existence of a second future subset of information of the second set of information.

In some embodiments, the first network entity comprises a PDN GW.

In various embodiments, the first network entity further comprises a SMF.

In one embodiment, a second network entity performs the procedure on the buffered data, and the second network entity comprises an USS server.

In certain embodiments, the procedure comprises: an UUAA; C2 authorization for C2 communications; or a combination thereof.

In some embodiments, the buffered data comprises: an UAV ID of a UAV; an USS address; a USS server UUAA aviation payload; or a combination thereof.

In various embodiments, the buffered data comprises: an UAV ID of a UAV; an UAS container comprising UAV pairing information; flight authorization information; or a combination thereof.

In one embodiment, an apparatus comprising: a processor; a memory coupled to the processor, the processor configured to cause the apparatus to: receive, from a network entity, a message comprising a container, the container comprising: a subset of information of a set of information; and an indicator that indicates existence of a future subset of information of the set of information; buffer data based at least in part on the subset of information of the set of information; and analyze the buffered data in response to the indicator indicating no existence of the future subset of information of the set of information.

In certain embodiments, the container further comprises a segment number that identifies the subset of information, and the buffered data is buffered based on the segment number.

In some embodiments, the network entity comprises a PDN GW.

In various embodiments, the network entity is co-located with a SMF.

In one embodiment, the buffered data comprises: a result for an USS server UUAA; a UAV ID of a UAV; a UUAA authorization payload; or a combination thereof.

In certain embodiments, the buffered data comprises: a result for authorization of C2 communications; C2 session security information; an UAV ID of a UAV; flight authorization information; or a combination thereof.

In some embodiments, to analyze the buffered data, the processor is configured to cause the apparatus to determine that the apparatus has an authorization for USS services, an UAV ID, a UUAA authorization payload, or a combination thereof.

In various embodiments, to analyze the buffered data, the processor is configured to cause the apparatus to determine that the apparatus has an authorization for C2 communications, an UAV ID, a C2 session security information, flight authorization information, or a combination thereof.

In one embodiment, a method at a device, the method comprising: receiving, from a network entity, a message comprising a container, the container comprising: a subset of information of a set of information; and an indicator that indicates existence of a future subset of information of the set of information; buffering data based at least in part on the subset of information of the set of information; and analyzing the buffered data in response to the indicator indicating no existence of the future subset of information of the set of information.

In certain embodiments, the container further comprises a segment number that identifies the subset of information, and the buffered data is buffered based on the segment number.

In some embodiments, the network entity comprises a PDN GW.

In various embodiments, the network entity is co-located with a SMF.

In one embodiment, the buffered data comprises: a result for an USS server UUAA; a UAV ID of a UAV; a UUAA authorization payload; or a combination thereof.

In certain embodiments, the buffered data comprises: a result for authorization of C2 communications; C2 session security information; an UAV ID of a UAV; flight authorization information; or a combination thereof.

In some embodiments, the method further comprises, to analyze the buffered data, determining that the apparatus has an authorization for USS services, an UAV ID, a UUAA authorization payload, or a combination thereof.

In various embodiments, the method further comprises, to analyze the buffered data, determining that the apparatus has an authorization for C2 communications, an UAV ID, a C2 session security information, flight authorization information, or a combination thereof.

In one embodiment, an apparatus comprising: a processor; and a memory coupled to the processor, the processor configured to cause the apparatus to: receive, from a device, a first message comprising a first container, the first container comprising: a first subset of information of a first set of information; and a first indicator that indicates existence of a first future subset of information of the first set of information; buffer data based at least in part on the first subset of information of the first set of information; and perform a procedure on the buffered data in response to the first indicator indicating no existence of the first future subset of information of the first set of information.

In certain embodiments, the first container further comprises a first segment number that identifies the first subset of information, and the buffered data is buffered based on the first segment number.

In some embodiments, the processor is further configured to cause the apparatus to transmit, to the device, a second message comprising a second container, the second container comprising: a second subset of information of a second set of information; and a second indicator that indicates existence of a second future subset of information of the second set of information.

In various embodiments, the second container further comprises a second segment number that indicates the second subset of information.

In one embodiment, the apparatus comprises a PDN GW.

In certain embodiments, the apparatus is co-located with a SMF.

In some embodiments, a second network entity performs the procedure on the buffered data, and the second network entity comprises an USS server.

In various embodiments, the procedure comprises: an USS server UUAA; C2 authorization for C2 communications; or a combination thereof.

In one embodiment, the buffered data comprises: an UAV ID of a UAV; an USS address; a USS server UUAA aviation payload; or a combination thereof.

In certain embodiments, the buffered data comprises: an UAV ID of a UAV; an UAS container comprising UAV pairing information; flight authorization information; or a combination thereof.

In one embodiment, a method at a first network entity, the method comprising: receiving, from a device, a first message comprising a first container, the first container comprising: a first subset of information of a first set of information; and a first indicator that indicates existence of a first future subset of information of the first set of information; buffering data based at least in part on the first subset of information of the first set of information; and performing a procedure on the buffered data in response to the first indicator indicating no existence of the first future subset of information of the first set of information.

In certain embodiments, the first container further comprises a first segment number that identifies the first subset of information, and the buffered data is buffered based on the first segment number.

In some embodiments, the method further comprises transmitting, to the device, a second message comprising a second container, the second container comprising: a second subset of information of a second set of information; and a second indicator that indicates existence of a second future subset of information of the second set of information.

In various embodiments, the second container further comprises a second segment number that indicates the second subset of information.

In one embodiment, the first network entity comprises a PDN GW.

In certain embodiments, the first network entity is co-located with a SMF.

In some embodiments, a second network entity performs the procedure on the buffered data, and the second network entity comprises an USS server.

In various embodiments, the procedure comprises: an USS server UUAA; C2 authorization for C2 communications; or a combination thereof.

In one embodiment, the buffered data comprises: an UAV ID of a UAV; an USS address; a USS server UUAA aviation payload; or a combination thereof.

In certain embodiments, the buffered data comprises: an UAV ID of a UAV; an UAS container comprising UAV pairing information; flight authorization information; or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Please make the following amendments to the claims:

1. A user equipment (UE), comprising:
at least one memory; and
at least one processor coupled with the at least one memory and configured to cause the UE to:
receive, from a network entity, a message comprising a container, the container comprising:
a first subset of information of a set of information;
a first indication that identifies the first subset of information; and
a second indication that indicates existence of a second subset of information of the set of information;
buffer data based at least in part on the first subset of information and the first indication; and
analyze the buffered data in response to the second indication indicating no existence of the second subset of information.

2. The UE of claim 1, wherein the network entity comprises a public data network (PDN) gateway (GW).

3. The UE of claim 1, wherein the network entity further comprises a session management function (SMF).

4. The UE of claim 1, wherein the buffered data comprises:
a result for an uncrewed aerial system (UAS) service supplier (USS) uncrewed aerial vehicle (UAV) authorization/authentication (UUAA);
a UAV identifier (ID) of a UAV;
a UUAA authorization payload;
or a combination thereof.

5. The UE of claim 1, wherein the buffered data comprises:
a result for authorization of command and control (C2) communications;
C2 session security information;
an uncrewed aerial vehicle (UAV) identifier (ID) of a UAV;
flight authorization information;
or a combination thereof.

6. The UE of claim 1, wherein, to analyze the buffered data, the at least one processor is configured to cause the UE to determine that the UE has an authorization for uncrewed aerial system (UAS) service supplier (USS) services, an uncrewed aerial vehicle (UAV) identifier (ID), a USS UAV authorization/authentication (UUAA) authorization payload, or a combination thereof.

7. The UE of claim 1, wherein, to analyze the buffered data, the at least one processor is configured to cause the UE to determine that the UE has an authorization for command and control (C2) communications, an uncrewed aerial vehicle (UAV) identifier (ID), a C2 session security information, flight authorization information, or a combination thereof.

8. An apparatus for performing a network function, the apparatus comprising:
at least one memory; and
at least one processor coupled with the at least one memory and configured to cause the apparatus to:
receive, from a device, a first message comprising a first container, the first container comprising:
a first subset of information of a first set of information;
a first indication that identifies the first subset of information; and
a second indication that indicates existence of a second subset of information of the first set of information;
buffer data based at least in part on the first subset of information and the first indication; and
perform a procedure on the buffered data in response to the second indication indicating no existence of the second subset of information.

9. The apparatus of claim 8, wherein the at least one processor is configured to cause the apparatus to transmit, to the device, a second message comprising a second container, the second container comprising:
a third subset of information of a second set of information;
a third indication that identifies the second subset of information; and
a fourth indication that indicates existence of a fourth subset of information of the second set of information.

10. The apparatus of claim 8, wherein a second network entity performs the procedure on the buffered data, and the second network entity comprises an uncrewed aerial system (UAS) service supplier (USS) server.

11. The apparatus of claim 8, wherein the procedure comprises:
an uncrewed aerial system (UAS) service supplier (USS) server uncrewed aerial vehicle (UAV) authorization/authentication (UUAA);
command and control (C2) authorization for C2 communications;
or a combination thereof.

12. The apparatus of claim 8, wherein the buffered data comprises:
an uncrewed aerial vehicle (UAV) identifier (ID) of a UAV;
an uncrewed aerial system (UAS) service supplier (USS) address;
a USS server UAV authorization/authentication (UUAA) aviation payload;
or a combination thereof.

13. The apparatus of claim 8, wherein the buffered data comprises:
an uncrewed aerial vehicle (UAV) identifier (ID) of a UAV;
an uncrewed aerial system (UAS) container comprising UAV pairing information;
flight authorization information;
or a combination thereof.

14. A user equipment (UE), comprising:
at least one memory; and
at least one processor coupled with the at least one memory and configured to cause the UE to:
receive, from a network entity, a message comprising a container, the container comprising:
a first subset of information of a set of information; and
a second indication that indicates existence of a second subset of information of the set of information;
buffer data based at least in part on the first subset of information; and
analyze the buffered data in response to the second indication indicating no existence of the second subset of information.

15. The UE of claim 14, wherein the buffered data comprises:
a result for an uncrewed aerial system (UAS) service supplier (USS) server uncrewed aerial vehicle (UAV) authorization/authentication (UUAA);
a UAV identifier (ID) of a UAV;
a UUAA authorization payload;
or a combination thereof.

16. A processor for wireless communication, comprising:
at least one controller coupled with at least one memory and configured to cause the processor to:
receive, from a network entity, a message comprising a container, the container comprising:
a first subset of information of a set of information;
a first indication that identifies the first subset of information; and
a second indication that indicates existence of a second subset of information of the set of information;
buffer data based at least in part on the first subset of information and the first indication; and
analyze the buffered data in response to the second indication indicating no existence of the second subset of information.

17. The processor of claim 16, wherein the network entity comprises a public data network (PDN) gateway (GW).

18. The processor of claim 17, wherein the network entity further comprises a session management function (SMF).

19. The processor of claim 16, wherein the buffered data comprises:
a result for an uncrewed aerial system (UAS) service supplier (USS) uncrewed aerial vehicle (UAV) authorization/authentication (UUAA);
a UAV identifier (ID) of a UAV;
a UUAA authorization payload;
or a combination thereof.

20. The processor of claim 16, wherein the buffered data comprises:
a result for authorization of command and control (C2) communications;
C2 session security information;
an uncrewed aerial vehicle (UAV) identifier (ID) of a UAV;
flight authorization information;
or a combination thereof.
